(19) United States
(12) Patent Application Publication
(10) Pub. No.: US 2006/0167996 A1
(43) Pub. Date: Jul. 27, 2006

(54) System and method for enabling electronic presentations

(76) Inventors: Garry S. Orsolini, Fair Oaks, CA (US); Kevin Hutler, Foresthill, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/036,499

(22) Filed: Jan. 13, 2005

(51) Int. Cl. G06F 15/16

(52) U.S. Cl. 709/204

(57) ABSTRACT

A system and method is provided for enabling collaborative electronic presentations. The method can include the operation of taking a snapshot of a shared application. The snapshot can be initiated by a snapshot control accessible to the user. Another operation can be linking the snapshot control to an electronic whiteboard to provide communication between the snapshot control and the electronic whiteboard. Once a link has been established, then the operation of transferring the snapshot to the electronic whiteboard in response to activation of the snapshot control can take place. A further operation is moving the whiteboard to a foreground for use by the user. The snapshot can be displayed in a whiteboard annotation area and moved to the foreground in response to the snapshot control activation. In addition, the snapshot in the whiteboard annotation area can be annotated upon by the user.

### BACKGROUND

Virtual collaboration and electronic conferencing tools allow individuals in many locations to share desktop display and content. These collaboration and conferencing tools enable users to present and share slides, applications, files or the user's desktop to a large (or small) group of people in real-time using a web browser or networked application. Using networked conferencing as a meeting alternative or to enrich face-to-face meetings is quickly becoming a part of business communications.

Such virtual collaboration tools can reduce the amount of time people spend shuffling to and from meetings. Although meetings are an essential part of business, meetings can take up the majority of time in the average business person's day. When meetings are more productive, this can enhance the business value of the meetings.

Scheduled or ad-hoc, electronic meetings can reduce costs and increase productivity. Electronic sharing tools encourage collaboration, expedite decision-making and enhance interactions with customers, partners, and colleagues. In addition, software under development or products can be demonstrated to anyone quickly without significant expense. For example, virtual collaboration can allow users to show electronic slideshows, demonstrate product features, show videos, and review documentation.

Virtual collaboration environments enable users to provide a number of valuable functions due to the nature of electronic sharing. For example, users can jointly view, annotate, or edit word processing documents in real time. Users can collaborate on presentation material and communicate without the expense of traveling. In addition, users of conferencing systems can deliver high quality, time-critical training without generally worrying about hardware or software issues.

When electronic desktop and application sharing meetings take place, the users may desire to use an electronic whiteboard in the presentation. This allows all the meeting participants to draw or make notes using the whiteboard. In addition, images that are displayed on the whiteboard can be annotated upon. Another function of collaboration and conferencing tools is the ability to share and transmit a live shared application to participants of a conference. For example, software developers may demonstrate a beta version of their product for customers to allow them to see the current version and provide feedback to the development team. Collaboration tools allow meeting participants to see the live shared application actually running on the presenter's desktop while the presenter is using, demonstrating, and discussing the shared application.

Unfortunately, switching between shared live applications and whiteboard annotation during virtual collaboration meetings or electronic learning sessions is rather difficult. Not only can it be difficult to switch between live content and whiteboard content but the complexity of switching back and forth can interrupt the flow of the presentation or interaction. With many types of collaboration tools, this type of switching is not even possible and it is overly difficult in others.

One difficulty in moving back and forth between a live shared application and a whiteboard is that collaboration tools allow users to run application sharing or use the snapshot tool but these two tools cannot generally be run simultaneously. Particularly, a user of a collaboration tool will have to stop live application sharing in order to use other functions in a collaboration tool. This also means that the participants receiving the shared application will not see the shared application from the presenter during that time period. For example, the live application sharing pane may turn black.

Stopping the application sharing tool allows the presenter to switch to a snapshot tool and take a snapshot of the live application while the application is not being shared. The snapshot may then be opened in a whiteboard tool and the participants of the presentation can make whiteboard annotations. Finally, when the presenter wants to demonstrate the live application again, then the live application sharing is restarted by the presenter. All of these steps may take several minutes and severely interrupt the flow of the presentation.

If a presenter wants to reduce the time it takes to load application shapshot into a whiteboard, then the presenter may save images to a storage location or hard drive in advance. Then the users can load the saved images into the whiteboard for annotation. This method usually means that the users prepare information before a conference and then drag and drop or open the graphics files into the whiteboard during a meeting. This process can be relatively burdensome and the pre-created snapshots may not exactly match up with what ends up being presented in the live demonstration. Moreover, the application sharing functions still have to be shut down to use the whiteboard functions using this approach.

### SUMMARY

The present invention includes a system and method for enabling collaborative electronic presentations. The method can include the operation of taking a snapshot of a shared application. The snapshot can be initiated by a snapshot control accessible to the user. Another operation can be linking the snapshot control to an electronic whiteboard to provide communication between the snapshot control and the electronic whiteboard. Once a link has been established, then the operation of transferring the snapshot to the electronic whiteboard in response to activation of the snapshot control can take place. A further operation is moving the whiteboard to a foreground for use by the user. The snapshot can be displayed in a whiteboard annotation area and moved to the foreground in response to the snapshot control activation. In addition, the snapshot in the whiteboard annotation area can be annotated upon by the user.

### BRIEF DESCRIPTION OF THE DRAWINGS

FIG. 1 is a flow chart illustrating a method for enabling collaborative electronic presentations in accordance with an embodiment;

FIG. 2 illustrates a control screen for an application sharing and snapshot application in accordance with an embodiment;

FIG. 3 depicts a whiteboard in accordance with an embodiment;

FIG. 4 illustrates an embodiment of a snapshot toolbar and an active application;

FIG. 5 illustrates a snapshot as displayed in a whiteboard used in an embodiment;

FIG. 6 illustrates an annotated snapshot as displayed in a whiteboard in an embodiment; and

FIG. 7 is a block diagram illustrating an embodiment of a system for enabling a user to give a presentation of a live application using collaboration software and annotate captured graphic information from the live application presentation.

### DETAILED DESCRIPTION OF EXAMPLE EMBODIMENT(S)

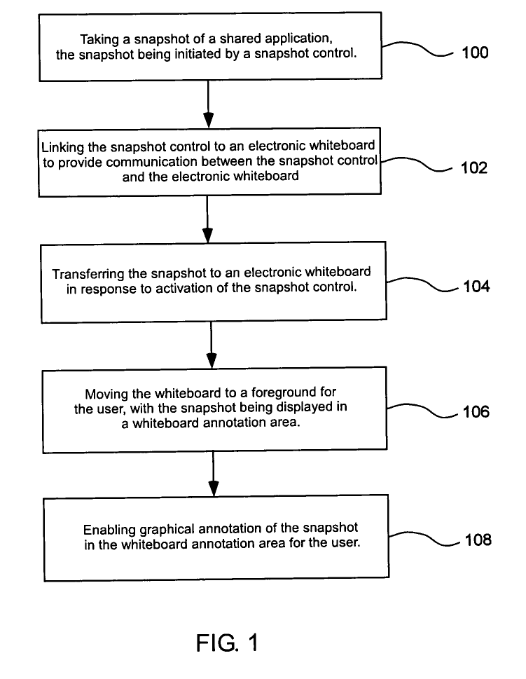

A system and method is provided for enabling collaborative electronic presentations. One embodiment of a method for the present system and method is illustrated in FIG. 1. The method can include the operation of taking a snapshot of a shared application as in block 100. The snapshot can be initiated by a snapshot control accessible to the user. The user can access this snapshot control or button while the user is using an active application. An active application is generally defined here as an application or active display content that is being executed, shared, displayed, or demonstrated by an electronic presenter. The snapshot button can be separately contained within a window or toolbar on the user's desktop. For example, the snapshot button can be part of an electronic presentation or collaboration application.

Another operation of the present method is linking the snapshot control to an electronic whiteboard to provide communication between the snapshot control and the electronic whiteboard as in block 102. This linking can be created using a pre-compiled program link or a dynamic link created using an object linking framework provided in the operating system (e.g. object automation containers).

Once the snapshot has been captured and the appropriate link to the whiteboard has been created, then the snapshot can be transferred to an electronic whiteboard as in block 104. This transfer of the snapshots is in response to the activation of a snapshot control. Since the electronic whiteboard has been linked with the snapshot control, then the whiteboard can receive a snapshot from the snapshot control after the snapshot is taken. For example, a user may be demonstrating an active or “live” application and a snapshot can be taken of that active application. Alternatively, a snapshot of the user's desktop or other user interface area can be taken.

Another operation that can occur when the snapshot button is activated by a user is the whiteboard can be launched and moved to a foreground of the user interface for use by the user 106. The foreground can be considered a topmost window with the user interface focus or any location where the user can directly access the whiteboard. The whiteboard may be brought into the user's focus automatically as a result of taking the individual snapshot. The snapshot can then be displayed in a whiteboard annotation area in response to the snapshot control activation.

The snapshot can be graphically annotated upon in the whiteboard annotation area for the user as in block 108. The whiteboard annotation area can include tools that allow either the presenter or members of the electronic presentation audience to make direct annotations to the snapshot without moving or dragging images into the whiteboard. The annotation tools in the whiteboard may include freehand writing tools, text tools, geometric object tools and similar graphic drawing functions.

One embodiment provides a seamless transition from demonstrating an active application to the annotation of a snapshot of the active application by the user. This allows a presenter to concentrate on making the presentation of the active content or demonstrated application, and users can avoid struggling with previously saved snapshots and transferring those snapshots to a whiteboard application that is separate from the collaboration or desktop sharing program.

Previously, a user prepared snapshots for a presentation in advance and then moved the snapshots over into the annotation tool. Loading these snapshots took many clicks of a mouse or many keystrokes. Creating a snapshot of an active application, then saving the snapshot and reopening the snapshot in the whiteboard can also be difficult or time consuming. Because the previous methods of using a snapshot with a whiteboard takes multiple user interface actions, users have not desired to annotate images during the presentation of active applications or other live content. In addition, annotation was previously so complicated that it interfered with the presentation flow and the presenter's mental train of thought.

Generally speaking, presentation flow has been considered more important than providing annotations when demonstrating a live application or live desktop. However, annotations are valuable for collaboration and the present system and method combines the advantages of presenting active or live content with the use of graphical annotations on a whiteboard. The present system and method also maintains presentation flow while allowing graphic annotations to be made easily.

The snapshot control can be located in a shared application that is accessible to the presenter of the active application. Particularly, the user may desire to take snapshots of a currently active software application or software being demonstrated in the user interface. Accordingly, the snapshot control is located such that it will be available when the active application is being used. The snapshot control can be configured to remain on top or as a sidebar that will not be covered over by the active application.

Snapshots can be configured to take images of an active window, an active application, the entire presenter's desktop or a screen area that is defined by a presenter or user. For example, a user may be provided with a selection tool in order to select a portion of a screen where the snapshot is taken. However, taking a snapshot of either the entire desktop or an active application tends to provide more useful benefit for the user.

The snapshot control may be contained on or within a snapshot toolbar. The snapshot toolbar can include controls such as a snapshot button, a stop button, a pause button, and a resume button. The snapshot toolbar can reside on the desktop and be separate from the active application or snapshot target. In addition, the snapshot toolbar is configured to be available for use at anytime.

In addition to taking snapshots of active windows or the desktop, the present system can also take snapshots of computer video, animations, and other image streams that are being displayed by the presenter. A particular advantage of the present system and method is that it allows the presenter to seamlessly transfer snapshots of live video or active content directly to an electronic whiteboard. As described before, this is important because using whiteboard functions is difficult when use of a whiteboard interrupts the flow of their presentation.

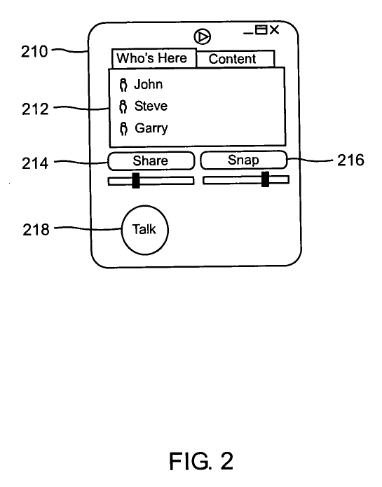

FIG. 2 illustrates a collaboration or desktop sharing application 210 that enables collaborative electronic presentations. The sharing application illustrates a number of individual users 212 who are involved in the sharing session in the “Who's Here” tab. The sharing application includes a share button 214 to start a sharing application and a snapshot button 216 to launch the snapshot interface or toolbar. Audio connections are also available using the talk button 218.

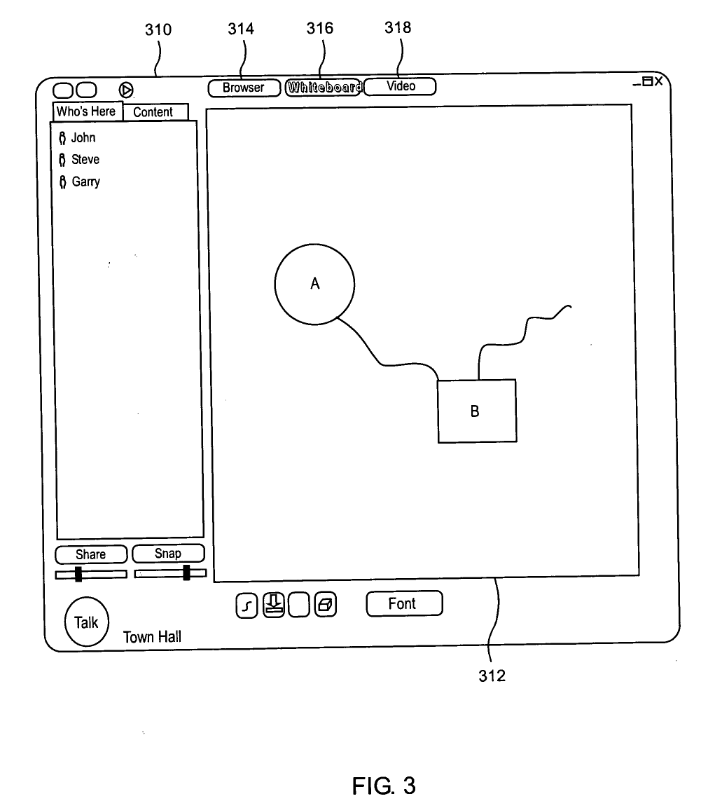

FIG. 3 illustrates a whiteboard 310 that can be provided to a user. The present whiteboard has a whiteboard area 312 that can be annotated in by a user. In addition, the whiteboard includes a number of controls for switching back and forth between Internet browsing 314, whiteboard functions 316, and video 318.

In previous systems, the whiteboard is independent of the sharing functionality or structure. For example, a sharing application is an application or a browser plug-in that is used on a receiver's desktop. However, whiteboard applications do not generally interact with such sharing applications. If a presenter in a sharing environment desires to provide shared content to a group of recipients then that content resides in the sharing application. In contrast, if the presenter wants the receivers of the shared content to view a whiteboard, then each of users need to independently switch to that separate whiteboard application. Unfortunately, the presenter does not know if each receiver has the technical knowledge to switch between the sharing application and the whiteboard or how long a switch might take. This uncertainty interrupts the flow of the presentation.

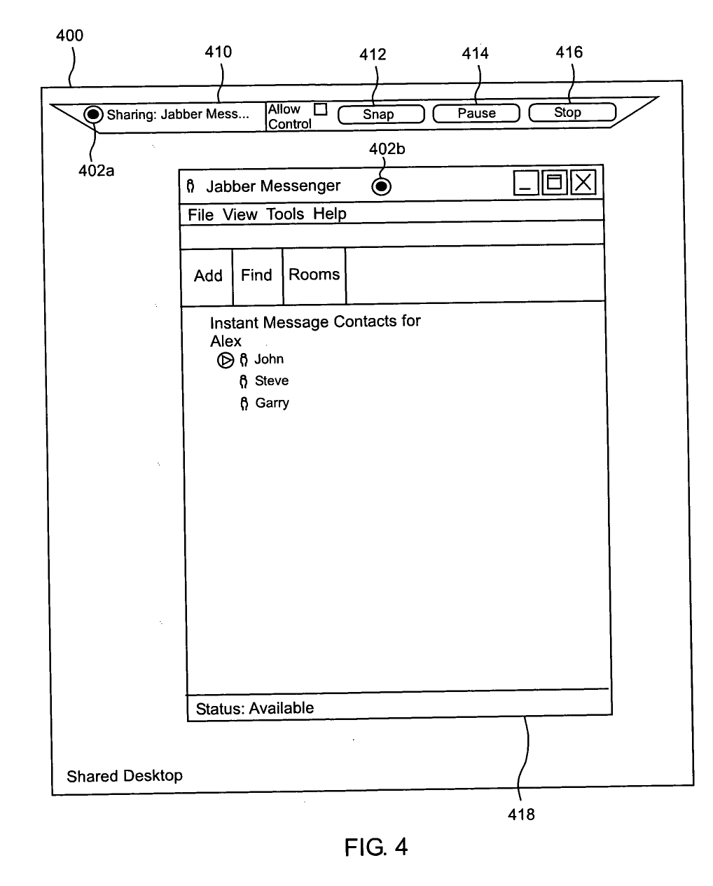

FIG. 4 illustrates part of a system for enabling a user to give an electronically shared presentation along with annotation of captured graphic information. Particularly, a shared desktop 400 is shown where electronic collaboration and media sharing can take place. An active application 418 or a “live” application is displayed on the desktop. For example, the active or live application can be a presenter's demonstration of an actual application in use by the presenter. The active application may be any type of application that can execute in a computing environment including a stand-alone, networked, graphical, non-graphical, or other type of software application.

In this example, an instant messaging application 418 is illustrated as being shared. The link between the application and the snapshot control 412 is denoted by the dot on each of the applications as 402a and 402b. A snapshot toolbar 410 is included to provide a snapshot interface to the user. This snapshot toolbar is separate from the active application so that the toolbar can be placed on top of the active application or moved around as desired by the user. A snapshot control 412 or button is configured to initiate a snapshot of the shared application. In the illustration of FIG. 4, the shared application is an active application 418. However, the shared application for the snapshot may be defined as the entire user desktop or a custom area selected by the user.

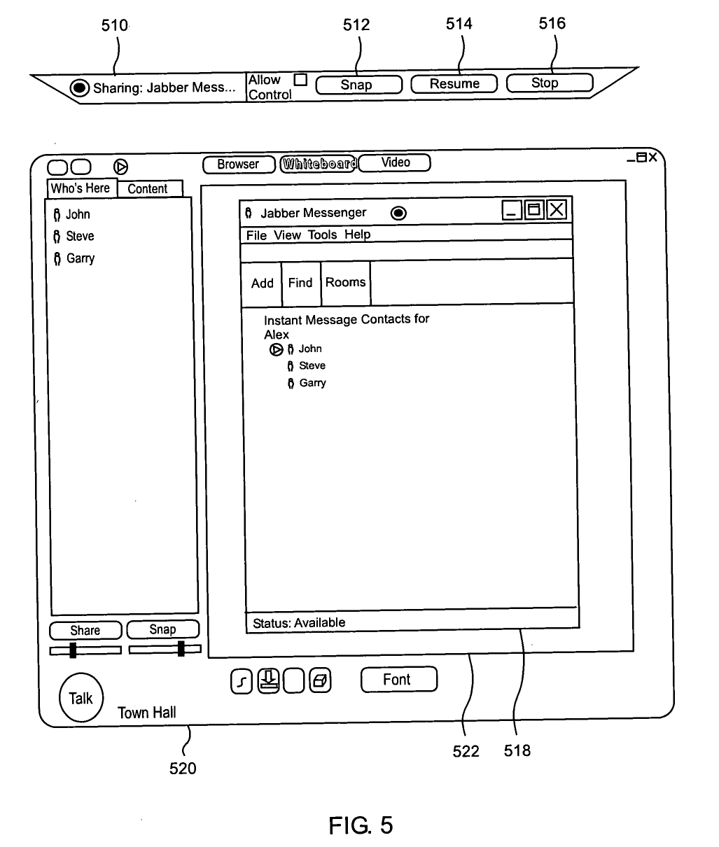

FIG. 5 illustrates what happens when a snapshot is taken. A whiteboard 520 is provided that is linked to the snapshot control. The whiteboard includes a whiteboard annotation area 522 that can display the snapshots 518 received from the snapshot control 512. These snapshots are transferred directly from the snapshot control to the whiteboard via the software link upon the single clicking of the snap button. This means that no additional user action needs to be taken to send the information to the whiteboard.

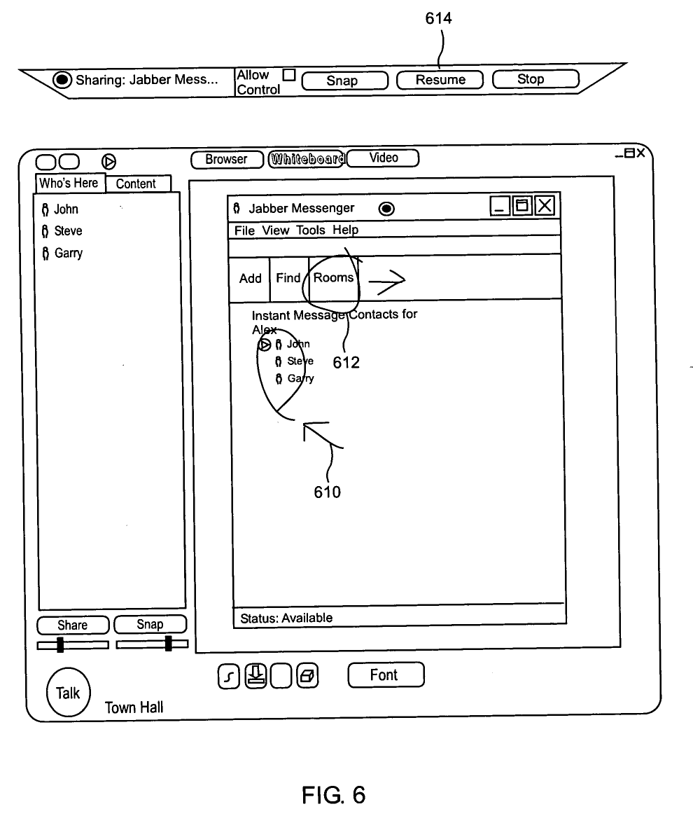

FIG. 6 further illustrates that annotations using free hand or other graphics tools can be made on the snapshot in the whiteboard. In the example of FIG. 6, annotations 610, 612 have been made by the presenter and/or receivers of the shared application to provide feedback for a presenter. For example, one annotation 612 may indicate that a certain button should be moved over, expanded, or changed. In addition, another annotation 610 may indicate that larger icons should be used in the application.

Once the annotation is complete, the resume control 614 can be used to immediately resume the activity of the active program and hide, close, or send the whiteboard behind other windows. The resume control can return the active application's state to the state before the snapshot was taken. An example of this would be FIG. 6 returning to the state illustrated in FIG. 4.

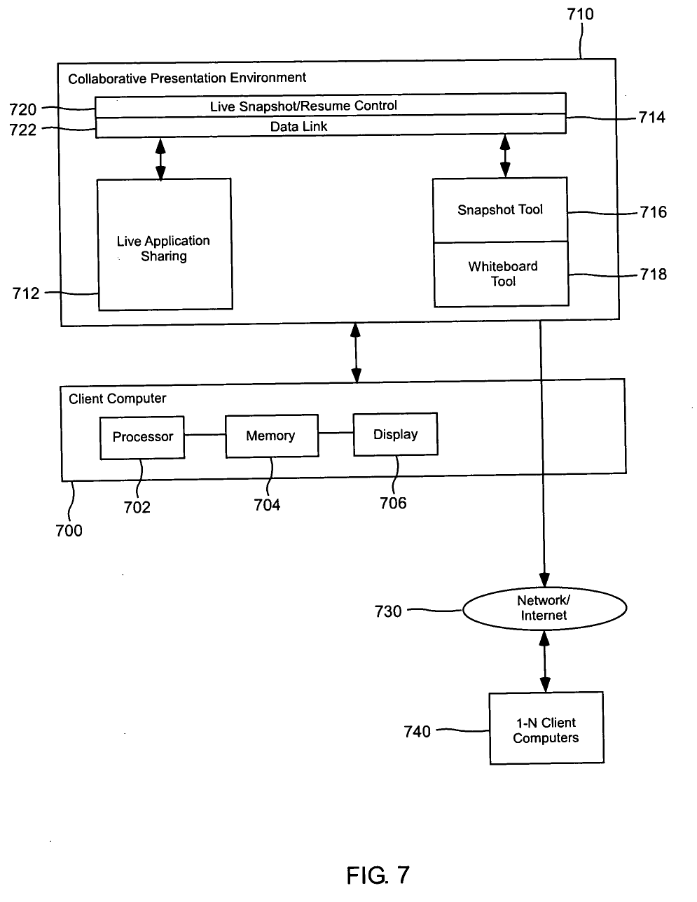

FIG. 7 is a block diagram illustrating a system for enabling a user to give a presentation of a live application using collaboration software and annotate captured graphic information from the live application presentation. A collaborative presentation environment 710 can be executing on a client computer 700.

The client computer 700 may include a processor 702, an electronic memory 704, a display device 706, and other related systems. In addition, the client computer can connect to a computer network or the Internet 730. This network connection allows the client computer to connect to any number of additional client computers 740 which have the collaborative presentation environment executing on them.

The collaborative presentation environment may contain a snapshot tool 716 that allows the user of the client computer to take a snapshot of a desktop (when application sharing has not pre-empted other collaborations functions) and move the snapshots to a whiteboard tool 718 for annotation. A live application sharing module 712 is provided that allows the presenter to share a live application with many other users of the collaborative presentation tool over the network while the live application is executing.

A live snapshot control 720 is configured to initiate a snapshot of a live shared application. This snapshot may be automatically transferred to the whiteboard through the data link 722 between the live application sharing tool and the whiteboard. The whiteboard may be configured to display snapshots received from the snapshot control when the snapshot control is initiated. In addition, a resume control 720 is configured to resume activity of the shared application, then the focus may be returned to the background and the live application sharing may take center focus. For example, the resume control may be a resume button that is dynamically displayed on a snapshot toolbar when the snapshot is being displayed in the whiteboard. The live shapshot control and resume control can be contained in a toolbar to provide a live application snapshot interface to the user.

In one embodiment, the resume button is not displayed before the snapshot is taken. The resume button is provided after the snapshot is taken to allow the user or presenter to hide the whiteboard and return to the sharing mode. This resume button configuration allows the presenter and the receivers of the shared content to return to the active application or active content in one operation. In addition, the resume button can hide or close the whiteboard without any additional user intervention, even though the whiteboard is a separate application from the sharing application. Alternatively, the resume button can be continuously displayed in the toolbar and enabled when the button's functionality is available.

Although the snapshot toolbar is illustrated as having snapshot and resume controls that are buttons, other types of user interface controls might be used. For example, the snapshot control may be a hyperlink, menu, dropdown list, or some other user control that can start the snapshot process and send the snapshot immediately to the whiteboard. Of course other applications, windows, or displayed information may also be presented by the computing environment along with the active application and any snapshot may include this additional information if desired.

A valuable result of the present system and method is that the individual giving a presentation using desktop sharing or electronic collaboration tools does not need to be preoccupied with the snapshot tool when they desire to provide annotations of what they are showing. Using a snapshot that goes directly to a whiteboard via a link and bringing the whiteboard to the front focus, enables the user to push one button to start making annotations without interrupting the flow of the presentation. Then when the annotation is complete, the user can return to the original active application, video, or other active content. In previous methods of desktop sharing, a desktop snapshot could be taken, but there has been no method to automatically send to the snapshot any other tool or whiteboard.

In the past, users who wanted to view the whiteboard during a collaborative presentation session have had to shut down the application sharing functions in order to use the snapshot and whiteboard tools in the collaborative environment. This means that a presenter may be giving a presentation to important clients or hundreds of viewers for a live shared application but if the presenter wants to annotate a snapshot of the application, then the application sharing has to be shutdown and the recipients cannot see the live application. Then the audience will wait until the snapshots are taken and annotated on the whiteboard before the live application sharing is restarted and the audience can see the live shared application again. In contrast, the present system and method is valuable because it allows presenters to make snapshots of live applications without shutting down the application sharing component. Then the snapshots from the live application can be sent to a whiteboard where edits or annotations can be immediately made. Then interface allows the presenter to quickly resume back to the original presentation and live application sharing with a single interface control action.

While the forgoing examples are illustrative of the present invention in one or more particular applications, it will be apparent to those of ordinary skill in the art that numerous modifications in form, usage and details of implementation can be made by one skilled in the art, and without departing from the principles and concepts of the invention. Accordingly, it is not intended that the invention be limited, except as by the claims set forth below.

1. A method for enabling collaborative electronic presentations, comprising the steps of:
taking a snapshot of a shared application, the snapshot being initiated by a snapshot control accessible to the user during application sharing;
linking the snapshot control to an electronic whiteboard to provide communication between the snapshot control and the electronic whiteboard;
transferring the snapshot to the electronic whiteboard in response to activation of the snapshot control;
moving the whiteboard to a foreground for use by the user, the snapshot being displayed in a whiteboard annotation area and the whiteboard being moved to the foreground in response to the snapshot control activation; and
enabling graphical annotation of the snapshot by the user in the whiteboard annotation area.

2. A method as in claim 1, wherein the step of taking a snapshot of a shared application further comprises the step of taking a snapshot of an active software application being used in a computer interface.

3. A method as in claim 1, wherein the step of taking a snapshot of a shared application further comprises the step of taking a snapshot of the user's graphical desktop in a computer interface.

4. A method as in claim 1, wherein the step of taking a snapshot of a shared application, further comprises the step of enabling a user to take a snapshot of a portion of the user's graphical desktop.

5. A method as in claim 1, wherein the step of taking a snapshot of a shared application, further comprises the step of taking a snapshot of a shared application which is defined by the user.

6. A method as in claim 1, further comprising the step of using the snapshot control with a snapshot toolbar that has at least two controls including the snapshot control and a resume control.

7. A method as in claim 6, further comprising the step of using the snapshot toolbar with a snapshot button and a resume button.

8. A method as in claim 1, further comprising the step of using application sharing or desktop sharing to provide the collaborative electronic presentations.

9. A method as in claim 1, wherein the step of taking a snapshot of a portion of a shared application, further comprises the step of enabling a user to take a snapshot of a video stream.

10. A method as in claim 1, wherein the step of transferring the snapshot to an electronic whiteboard further comprises the step of transferring the snapshot to an electronic whiteboard seamlessly without additional user interface instructions from the user.

11. A method for facilitating collaborative electronic presentations and annotation of graphic information captured from the electronic presentations into an electronic whiteboard, comprising the steps of:
enabling a user to take a snapshot of an active portion of a computer interface, the snapshot being activated by a snapshot button available on a user's desktop;
transferring the snapshot to the electronic whiteboard, without direction from a user and in response to activation of the snapshot control, wherein the whiteboard is directly linked to the snapshot button;
enabling annotation of the snapshot in the electronic whiteboard; and
resuming the viewing of the active portion of the interface where further snapshots can be taken.

12. A method as in claim 11, wherein the step of resuming the viewing of the active portion of the interface is initiated by a resume button.

13. A method as in claim 11, wherein the step of initiating a resume button further comprises the steps of:
hiding the whiteboard where annotations on the snapshot were made; and
restoring a view of an active software application.

14. A system for enabling a user to give a presentation using electronic media and annotate captured graphic information from the presentation, comprising:
a snapshot control configured to initiate a snapshot of a shared application;
a whiteboard linked to the snapshot control, the whiteboard being configured to display snapshots received from the snapshot control when the snapshot control is initiated; and
a resume control configured to resume activity of the shared application and to hide the whiteboard.

15. A system as in claim 14, further comprising a snapshot toolbar to provide a snapshot interface to the user.

16. A system as in claim 15, wherein the snapshot control is a snapshot button located in the snapshot toolbar.

17. A system as in claim 14, wherein the resume control is a resume button that is dynamically displayed on a snapshot toolbar when the snapshot is being displayed in the whiteboard.

18. A system as in claim 17, wherein the resume button resumes activity of an active program and restores the active program to focus for use by the user.

19. A system as in claim 14, wherein the snapshot control is configured to take a snapshot of the user's graphical desktop being used in the computer interface.

20. A system as in claim 14, wherein snapshot control is configurable by a user to take a snapshot of a portion of a computer interface.

21. A system for enabling a user to give a presentation using electronic media and annotate captured graphic information from the presentation, comprising:
a snapshot means for initiating a snapshot of a shared application;
a linking means for linking the snapshot control to a whiteboard means;
the whiteboard means for displaying snapshots received from the snapshot control when the snapshot control is initiated; and
a resume means for resuming activity of the shared application and hiding the whiteboard.

22. A system as in claim 21, further comprising a snapshot toolbar means for providing a snapshot interface to the user.

23. An article of manufacture, comprising:
a computer usable medium having computer readable program code means embodied therein for facilitating collaborative electronic presentations and annotation of graphic information captured from the electronic presentations into an electronic whiteboard, comprising:
computer readable program code for enabling a user to take a snapshot of an active portion of a computer interface, the snapshot being activated by a snapshot button available on a user's desktop;
computer readable program code for transferring the snapshot to the electronic whiteboard, without direction from a user and in response to activation of the snapshot control, wherein the whiteboard is directly linked to the snapshot button;
computer readable program code for enabling annotation of the snapshot in the electronic whiteboard; and
computer readable program code for resuming the viewing of the active portion of the interface where further snapshots can be taken.

24. An article of manufacture as in claim 23, further comprising computer readable program code for resuming the viewing of the active portion of the interface is initiated by a resume button.
